(19) United States
(12) Patent Application Publication
(10) Pub. No.: US 2009/0040109 A1
(43) Pub. Date: Feb. 12, 2009

(54) Antenna Device and Wireless Communication Device Using the Same

(76) Inventors: Akihiko Iguchi, Osaka (JP); Yuki Satoh, Osaka (JP); Misako Sasagawa, Kanagawa (JP)

Correspondence Address: RATNERPRESTIA, P.O. BOX 980, VALLEY FORGE, PA, 19482, US

(21) Appl. No.: 10/584,000

(22) PCT Filed: Jan. 31, 2006
(86) PCT No.: PCT/JP2006/301499

§ 371 Date: Jun. 22, 2006

(30) Foreign Application Priority Data
Mar. 15, 2005 (JP) 2005-072533
Sep. 22, 2005 (JP) 2005-275746

(51) Int. Cl. H01Q 1/38

(52) U.S. Cl. 343/700 MS

(57) ABSTRACT

An antenna device including a first Planar Inverted F Antenna (PIFA) operating at a first frequency and a second PIFA operating at a second frequency that is higher than the first frequency and disposed in a state in which it is insulated from the first PIFA. The antenna device has an antenna element in which a first short-circuit lead wire and a second short-circuit lead wire are coupled to a ground terminal provided on a substrate, a first feeding lead wire is coupled to a feeding terminal provided on a substrate via first matching circuit and a second feeding lead wire is coupled to a feeding terminal provided on the substrate via a second matching circuit. Thus, an antenna device which has a high degree of freedom for adjusting characteristics corresponding to a plurality of frequency bands can be realized.

### TECHNICAL FIELD

The present invention relates to an antenna device and a wireless communication device using the same.

### BACKGROUND ART

Wireless communication devices such as portable telephones have been operated as a complex system and in multiple bands. A wireless communication device has a built-in antenna device in its case. Such a wireless communication device is required to operate at plural frequencies and to have an antenna device that can be built in a case. As a conventional built-in antenna to be disposed in a case, a Planar Inverted F Antenna (hereinafter, referred to as “PIFA”) corresponding to multiple bands as shown in FIG. 9 is well known. The PIFA includes radiation conductor 101, ground conductor 102, short-circuit lead wire 103 for coupling radiation conductor 101 and ground conductor 102 to each other, and feeding lead wire 104 for supplying electric power to the antenna. By providing radiation conductor 101 with slit 105, electric current flowing in radiation conductor 101 can be divided so as to achieve operations in multiple bands. An antenna having such a configuration is disclosed in Japanese Patent Application No. H11-530597.

Conventionally, by coupling a matching circuit to feeding lead wire 104, desired characteristics can be realized. However, in an antenna device corresponding to multiple bands as shown in FIG. 9, when a characteristic of one frequency band is improved, a characteristic of another may be deteriorated. That is to say, the characteristics cannot be adjusted independently, so that it is difficult to improve characteristics in plural frequency bands simultaneously. Furthermore, when the length of radiation conductor 101 is varied to adjust an operation frequency, the other frequency may be changed.

### SUMMARY OF THE INVENTION

The present invention provides an antenna device including a first radiation conductor operating at a first frequency; a first feeding lead wire coupled to the first radiation conductor; a first matching circuit coupled to the first feeding lead wire; a first short-circuit lead wire coupled to the first radiation conductor and grounded; a second radiation conductor disposed in a state in which it is insulated from the first radiation conductor and operating at a second frequency that is higher than the first frequency; a second feeding lead wire coupled to the second radiation conductor; a second matching circuit coupled to the second feeding lead wire; a second short-circuit lead wire coupled to the second radiation conductor and grounded; and a transmitting/receiving circuit coupled to the first matching circuit and the second matching circuit.

Furthermore, the present invention provides a wireless communication device using the above-mentioned antenna device.

With such a configuration, since the first matching circuit is coupled to the first radiation conductor and the second matching circuit is coupled to the second matching circuit, a circuit can be designed in accordance with the frequency band in which each radiation conductor operates. Furthermore, even when a plurality of feeding lead wires are provided, they are coupled to one feeding terminal provided on a substrate via the first matching circuit and the second matching circuit. Therefore, a plurality of signal lines are not required to be provided. Furthermore, when the length of the radiation conductor is adjusted, since the first radiation conductor and the second radiation conductor are insulated from each other, an antenna device that is not easily influenced by another radiation conductor can be realized.

### BRIEF DESCRIPTION OF THE DRAWINGS

FIG. 1 is an electric circuit diagram of a wireless communication device to illustrate an antenna device.

FIG. 2 is a perspective view showing the antenna device shown in FIG. 1.

FIG. 3 is a perspective view showing an antenna device in accordance with a first exemplary embodiment of the present invention.

FIG. 4 is a perspective view showing another antenna device in accordance with the first exemplary embodiment of the present invention.

FIG. 5A shows charts to illustrate an influence of an impedance in accordance with the first exemplary embodiment of the present invention.

FIG. 5B shows charts to illustrate an influence of an impedance in accordance with the first exemplary embodiment of the present invention.

FIG. 6A is a perspective view showing an antenna device of another configuration in accordance with the first exemplary embodiment of the present invention.

FIG. 6B is a perspective view showing an antenna device of another configuration in accordance with the first exemplary embodiment of the present invention.

FIG. 7A is a perspective view showing an antenna device of another configuration in accordance with the first exemplary embodiment of the present invention.

FIG. 7B is a perspective view showing an antenna device of another configuration in accordance with the first exemplary embodiment of the present invention.

FIG. 8 is a perspective view showing an antenna device in accordance with a second exemplary embodiment of the present invention.

FIG. 9 is a perspective view showing a conventional antenna device.

### REFERENCE MARKS IN THE DRAWINGS

1 antenna element
22 printed circuit board
23 transmitting/receiving circuit
24 signal line
25 feeding terminal
26 ground terminal
27 first radiation conductor
28 first short-circuit lead wire
29 first feeding lead wire
30 second radiation conductor
31 second short-circuit lead wire
32 second feeding lead wire
33 spacer
34 terminal for holding antenna element
35 first matching circuit
36 second matching circuit
37 open end of first radiation conductor
38 open end of second radiation conductor
39 crosspiece

### DETAILED DESCRIPTION OF THE PREFERRED EMBODIMENTS

Hereinafter, examples of the exemplary embodiments of the present invention are described with reference to drawings. Note here that each drawing is a schematic view in which the positional relation is not shown correctly in terms of dimension. Furthermore, in the exemplary embodiments, a portable telephone is taken as an example of a wireless communication device. It is not intended that the present invention is limited to these exemplary embodiments.

### First Exemplary Embodiment

The first exemplary embodiment of the present invention is described with reference to drawings.

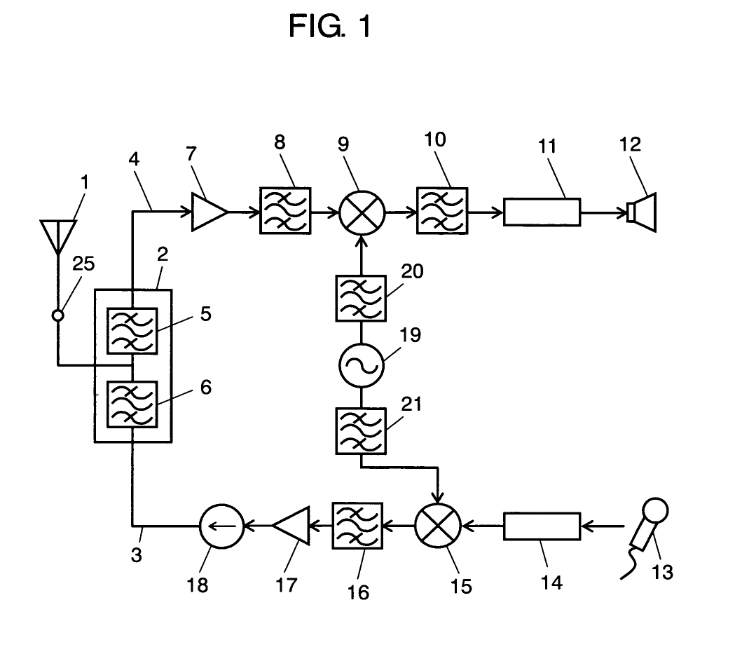

FIG. 1 shows an electric circuit of a portable telephone. Antenna element 1 is coupled to transmission line 3 and reception line 4 via antenna duplexer 2. Antenna duplexer 2 includes transmission filter 6 and reception filter 5. An electric wave received by antenna element 1 is transmitted to reception line 4 via antenna duplexer 2. Reception line 4 is coupled to loudspeaker 12 via amplifier 7, interstage filter 8, mixer 9, IF filter 10, and demodulator 11 in this order. In this way, the received electric wave is output as a voice.

Furthermore, a voice input to microphone 13 is output from antenna element 1 through transmission line 3 provided with modulator 14, mixer 15, interstage filter 16, amplifier 17, and isolator 18 and antenna duplexer 2.

Furthermore, voltage controlled oscillator (VCO) 19 is coupled to mixer 9 via filter 20 and coupled to mixer 15 via filter 21.

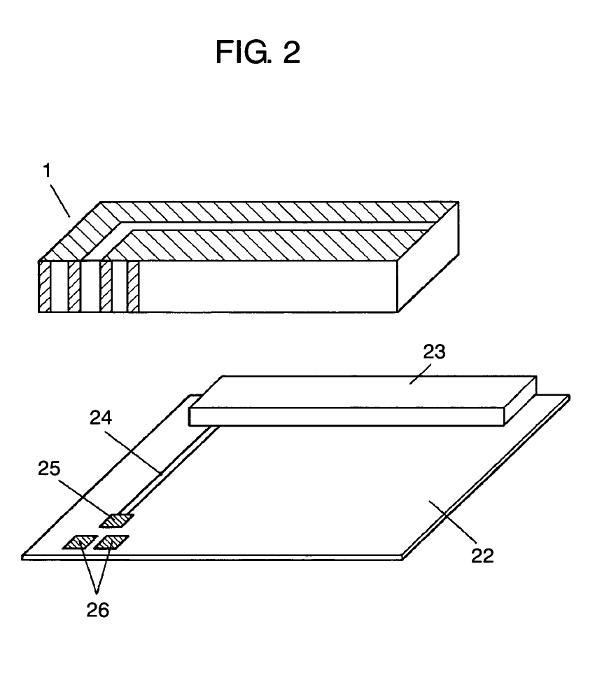

FIG. 2 shows a specific configuration of an antenna element. Transmitting/receiving circuit 23 including components on reception line 4 from antenna duplexer 2 to demodulator 11 and components on transmission line 3 from antenna duplexer 2 to modulator 14 is formed on printed circuit board 22. To transmitting/receiving circuit 23, signal line 24 is coupled. To signal line 24, feeding terminal 25 is coupled. As shown in FIG. 1, feeding terminal 25 is provided between antenna element 1 and antenna duplexer 2. Feeding terminal 25 is coupled to antenna element 1. Furthermore, printed circuit board 22 is provided with ground terminal 26.

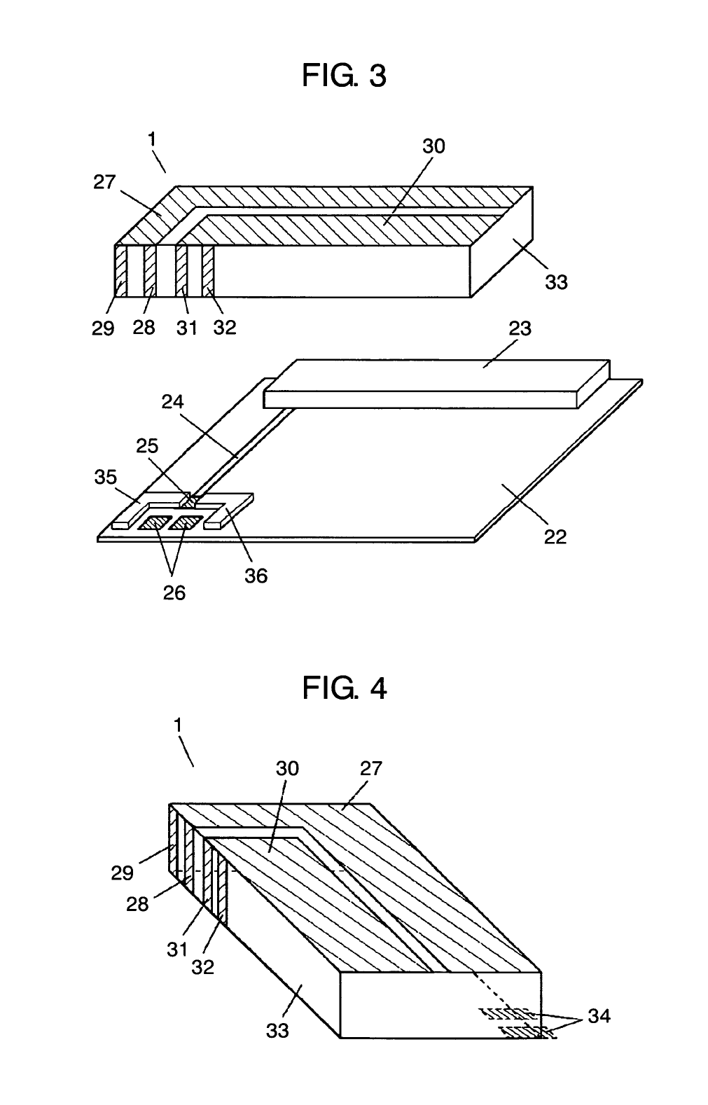

Next, FIG. 3 shows a configuration of the antenna device of the present invention. For example, the first operation frequency is 900 MHz and the second operation frequency is 1.8 GHz. A first Planar Inverted F Antenna (PIFA) operating at 900 MHz includes first radiation conductor 27, and first short-circuit lead wire 28 and first feeding lead wire 29, which are coupled to first radiation conductor 27, as shown in FIG. 3. Short-circuit lead wire 28 and feeding lead wire 29 are coupled to the same side of first radiation conductor 27 in a way in which they are provided with a predetermined distance therebetween. Furthermore, similar to the first PIFA, a second PIFA operating at 1.8 GHz includes second radiation conductor 30, second short-circuit lead wire 31 and second feeding lead wire 32. Herein, first radiation conductor 27 and second radiation conductor 30 are disposed in a state in which they are insulated from each other. Furthermore, antenna element 1 may be formed on the surface or inside spacer 33 made of a dielectric material such as ABS resin. The shape of spacer 33 is, for example, a rectangular parallelepiped. The use of spacer 33 prevents antenna element 1 from being deformed. In addition to this, by using the wavelength shortening effect by the dielectric constant of spacer 33, first radiation conductor 27 and second radiation conductor 30 can be miniaturized.

As the position relation of the lead wires, it is preferable that first short-circuit lead wire 28 and second short-circuit lead wire 31 are disposed between first feeding lead wire 29 and second feeding lead wire 32. With this configuration, first short-circuit lead wire 28 and second short-circuit lead wire 31 can be coupled to each other at their bottom parts. As a result, since the number of terminals of antenna element 1 can be reduced from four to three, it is not necessary to provide a plurality of ground terminals 26 on printed circuit board 22. First short-circuit lead wire 28 and second short-circuit lead wire 31 are coupled to ground terminal 26 electrically and mechanically. Furthermore, with this configuration, a larger electric current flows at the side of each short-circuit lead wire, and a smaller electric current flows at the side of each feeding lead wire. As a result, the influence from the feeding portion at the other side is reduced, so that isolation between antennas can be secured. First feeding lead wire 29 and second feeding lead wire 32 are coupled to first matching circuit 35 and second matching circuit 36, respectively. First matching circuit 35 and second matching circuit 36 are coupled to feeding terminal 25 on printed circuit board 22. First and second matching circuits 35 and 36 are not necessarily limited to elements such as a capacitor and an inductor, and they may be a transmission line or a zero Ω resistor. First matching circuit 35 is provided for improving the characteristic of 900 MHz band that is the first operation frequency. Second matching circuit 36 is provided for improving the characteristic of 1.8 GHz band that is the second operation frequency. Therefore, it is preferable that for first matching circuit 35, for example, a high-pass circuit capable of operating efficiently at 900 MHz is designed and that for second matching circuit 36, for example, a low-pass circuit capable of operating efficiently at 1.8 GHz is designed. Thus, to the first radiation conductor, the first matching circuit is coupled; and to the second radiation conductor, the second matching circuit is coupled. Therefore, each antenna can be set to an optimal impedance for each operation frequency band. As a result, it is possible to reduce the influence on the frequency band at the other side. Consequently, the characteristic can be improved in each frequency band.

Furthermore, as shown in FIG. 4, spacer 33 may be a surface mounted component (SMD) as follows. Spacer 33 is formed of heat-resistant resin such as polyphenylene sulfide, polyphthalimidine, and the like. Furthermore, terminals 34 for holding antenna element 1 are disposed on the surface facing the region in which short-circuit lead wires 28 and 31 and feeding lead wires 29 and 32 are formed. Thus, even when a plurality of terminals for antenna element 1 are necessary, by configuring spacer 33 as SMD, components can be mounted onto printed circuit board 22 stably. Furthermore, similar to the other components, since antenna element 1 can be supplied and assembled by using a part feeder, handling becomes easy.

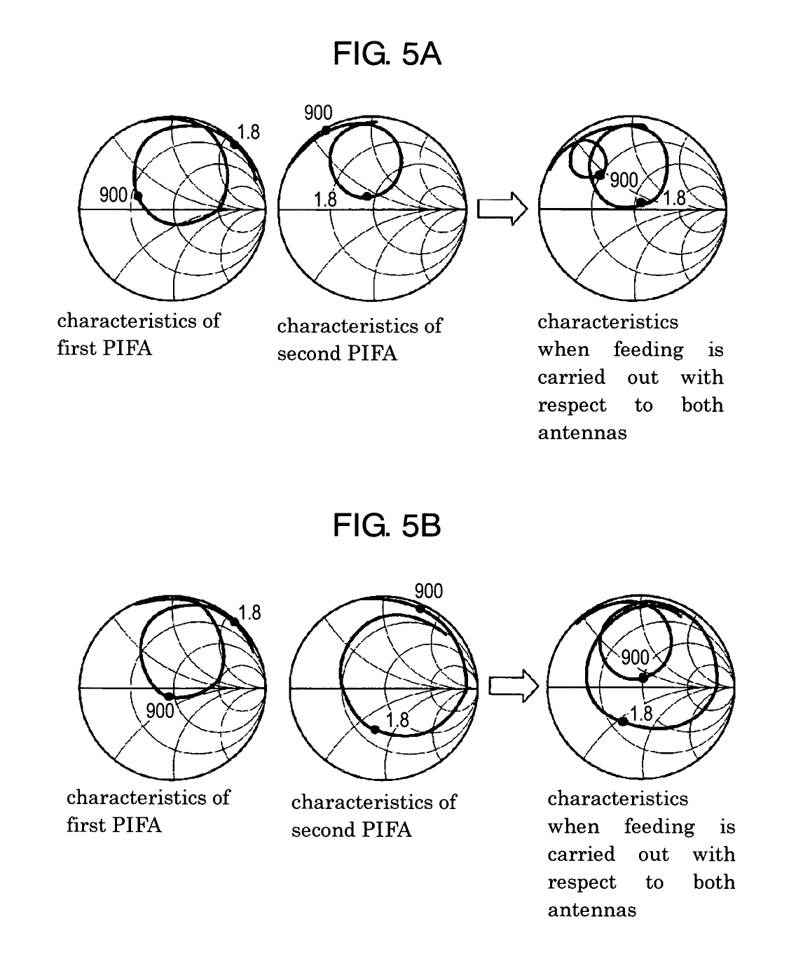

Furthermore, in order to reduce the influence on the frequency band at the other side, it is preferable that the first PIFA is configured so as to have a high impedance at the second frequency (1.8 GHz) and the second PIFA is configured so as to have a high impedance at the first frequency (900 MHz). FIGS. 5A and 5B are Smith Charts to illustrate the characteristic based on the difference in the impedance at the first frequency of the second PIFA. FIG. 5A shows a characteristic in the case where the second PIFA has a low impedance at the first frequency. FIG. 5B shows a characteristic in the case where the second PIFA has a high impedance at the first frequency. As in this configuration, when a single point feeding is carried out with respect to each PIFA, it is shown from the following description that the change in the characteristic of the first PIFA can be suppressed better in the case shown in FIG. 5B. In Smith Chart, the right end of the outermost circle is open (that is, impedance is ∞ Ω) and the left end is short-circuit (that is, impedance is zero Ω). Therefore, the right side of the chart means higher impedance. Marked positions of 900 MHz in the characteristic of the second PIFA in FIG. 5B are located right with respect to those in FIG. 5A. Therefore, in the first frequency (900 MHz), the impedance of the second PIFA shown in FIG. 5B is higher and an electric current is not likely to flow. In other words, when both feeding parts are coupled, the change in the characteristics of the first PIFA can be suppressed better in FIG. 5B. Note here that, numbers in FIGS. 5A and 5B, 900 and 1.8, represent the first frequency (900 MHz) and the second frequency (1.8 GHz), respectively.

Next, first radiation conductor 27 and second radiation conductor 30 for determining the operation frequency of antenna element 1 are described. In general, the operation frequency of an antenna is determined by the length of radiation conductor. Antenna element 1 of this configuration includes PIFA corresponding to each frequency band. PIFA produces a resonance when the length from the short-circuit end to the open end is about λ/4, and it operates as an antenna by radiating an electric wave by using the resonance electric current. The λ/4 mode herein denotes a resonance mode in which an electric current is maximum at the short-circuit part and an electric current is minimum and a voltage is maximum at the open end that is the most distant from the short-circuit part.

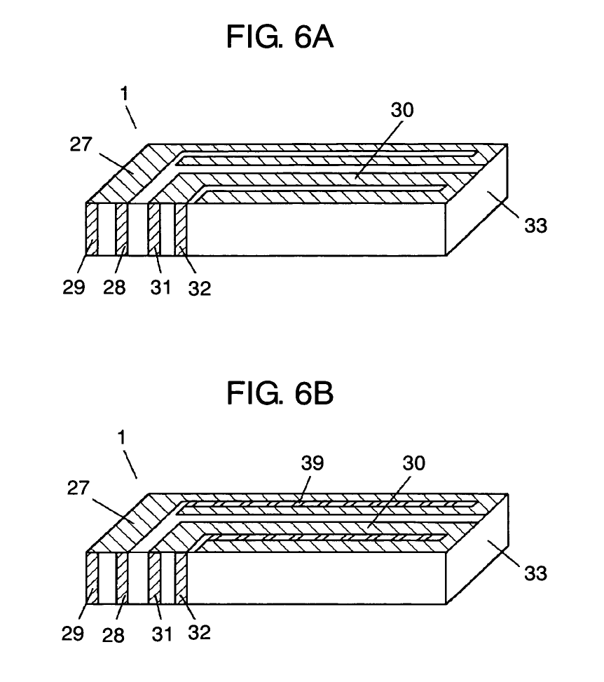

Note here that λ represents a wavelength at a resonance frequency. In order to allow first radiation conductor 27 and second radiation conductor 30 to operate in the desired frequency bands, first and second radiation conductors 27 and 30 may be provided with a slit as shown in FIG. 6A. At this time, crosspiece 39 may be provided in the slit part as shown in FIG. 6B. Then, since the operation frequency can be adjusted or changed by cutting crosspiece 39, it is not necessary to form an element by molding.

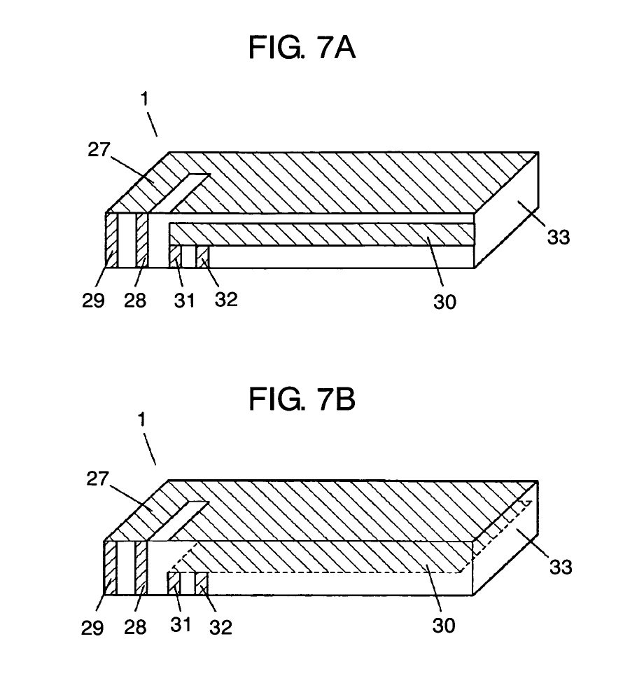

Furthermore, in FIG. 3, first and second radiation conductors 27 and 30 are formed on the same surface. However, as shown in FIGS. 7A and 7B, they may be formed on the different surfaces of rectangular parallelepiped-shaped spacer 33. With such a configuration, an area given to the antenna device can be used effectively.

Furthermore, in this exemplary embodiment, in FIG. 3, first radiation conductor 27 corresponding to the first operation frequency is formed at the outer side and second radiation conductor 30 corresponding to the second operation frequency is formed at the inner side. However, the first and second radiation conductors 27 and 30 may be formed at the opposite position. The same is true in FIGS. 7A and 7B, and the position relation between first radiation conductor 27 and second radiation conductor 30 and the operation frequency are not limited to this.

### Second Exemplary Embodiment

Hereinafter, an antenna device in accordance with a second exemplary embodiment of the present invention is described with reference to drawings. Unless otherwise specified, constituent features are the same as those in the first exemplary embodiment.

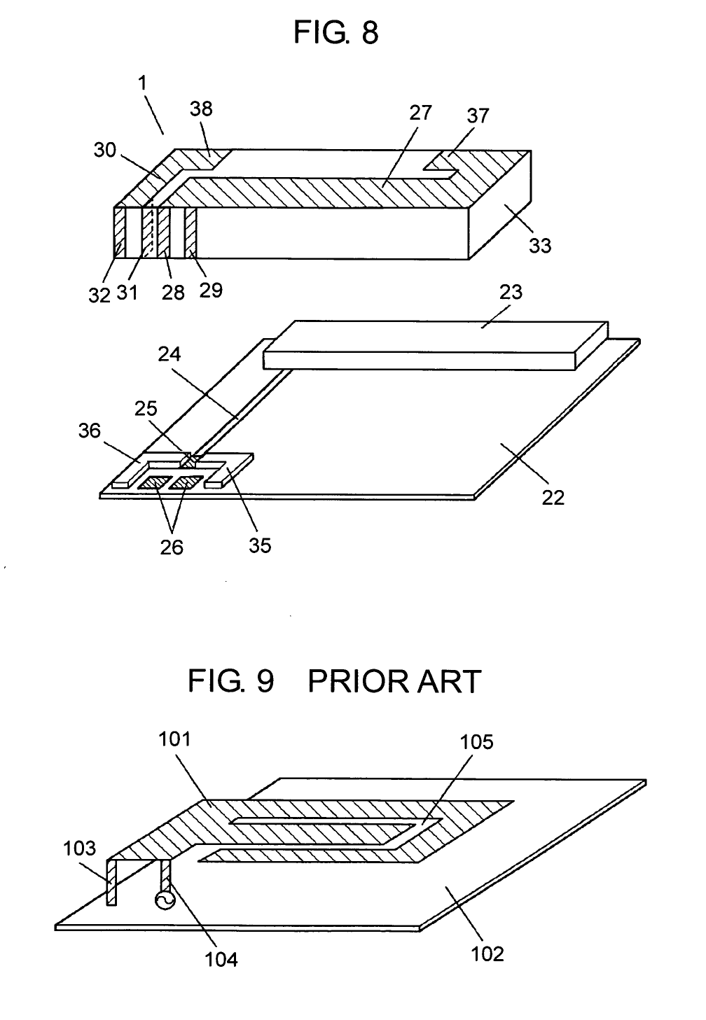

FIG. 8 shows an antenna device and a printed circuit board of a portable telephone in accordance with the second exemplary embodiment. In this configuration, since open end 37 of first radiation conductor 27 and open end 38 of second radiation conductor 30 are disposed oppositely and distantly from each other on the contour of spacer 33, an isolation between the radiation conductors can be secured. This is based on the advantage that binding between the conductors can be made small since open ends 37 and 38, which are in a high electric field, are disposed oppositely and distantly from each other.

Furthermore, an angle made by a plane of second short-circuit lead wire 31 and a plane of first short-circuit lead wire 28 becomes substantially 90°. Since a large electric current flows in the short-circuit lead wire, a line breadth is required to be secured to some extent. Therefore, when two short-circuit lead wires are aligned, an area in which ground terminal 26, first matching circuit 35 and second matching circuit 36 are formed becomes larger. However, as in this configuration, by disposing a plane of one short-circuit lead wire at 90° with respect to a plane of the other short-circuit lead wire, the interval between feeding lead wires can be narrowed. Thus, an area in which a circuit is formed can be made small so as to reduce the area to be used by a printed circuit board.

Furthermore, transmitting/receiving circuit 23 has load impedance Z1 that is suitable at the first frequency and load impedance Z2 that is suitable at the second frequency as characteristics of a semiconductor. In general, Z1 and Z2 are different from each other. In this configuration, the impedance of the first PIFA and the first matching circuit and the impedance of the second PIFA and the second matching circuit are adjusted independently. As a result, the impedance of the first PIFA can be made substantially equal to the load impedance at the first frequency. Similarly, the impedance of the second PIFA can be made substantially equal to the load impedance at the second frequency. As mentioned above, in accordance with the present invention, it is possible to provide a portable telephone having an excellent characteristic at each frequency.

### INDUSTRIAL APPLICABILITY

Since an antenna device of the present invention can improve the characteristic corresponding to each frequency band, it is suitable for an antenna device that needs adjustment with respect to plural frequency bands. Then, this antenna device can be widely used for wireless communication devices.

1. An antenna device comprising:
a first radiation conductor operating at a first frequency;
a first feeding lead wire coupled to the first radiation conductor;
a first matching circuit coupled to the first feeding lead wire;
a first short-circuit lead wire coupled to the first radiation conductor and grounded;
a second radiation conductor disposed in a state in which it is insulated from the first radiation conductor and operating at a second frequency that is higher than the first frequency;
a second feeding lead wire coupled to the second radiation conductor;
a second matching circuit coupled to the second feeding lead wire;
a second short-circuit lead wire coupled to the second radiation conductor and grounded; and
a transmitting/receiving circuit coupled to the first matching circuit and the second matching circuit.

2. The antenna device of claim 1,
wherein the first short-circuit lead wire and the second short-circuit lead wire are disposed between the first feeding lead wire and the second feeding lead wire.

3. The antenna device of claim 1,
wherein the first short-circuit lead wire and the second short-circuit lead wire are coupled to each other at their bottom parts.

4. The antenna device of claim 1,
wherein the first radiation conductor and the second radiation conductor are formed on a surface of or inside a spacer made of a dielectric substance.

5. The antenna device of claim 1,
wherein the first radiation conductor and the second radiation conductor are formed on different surfaces.

6. The antenna device of claim 1,
wherein at the first frequency, an impedance of the second radiation conductor is higher than an impedance of the first radiation conductor.

7. The antenna device of claim 1,
wherein at the second frequency, an impedance of the first radiation conductor is higher than an impedance of the second radiation conductor.

8. The antenna device of claim 1,
wherein the first radiation conductor and the second radiation conductor are provided with a crosspiece for adjusting a frequency.

9. The antenna device of claim 1,
wherein the first matching circuit comprises a high-pass circuit, and the second matching circuit comprises a low-pass circuit, respectively.

10. The antenna device of claim 4,
wherein a terminal for holding an antenna element is provided in a region facing a region in which the first and second feeding lead wires and the first and second short-circuit lead wires are coupled, respectively.

11. The antenna device of claim 1,
wherein at the first frequency, a load impedance of the transmitting/receiving circuit is substantially equal to an impedance from the first matching circuit to the first radiation conductor, and
at the second frequency, a load impedance of the transmitting/receiving circuit is substantially equal to an impedance from the second matching circuit to the first radiation conductor.

12. The antenna device of claim 1,
wherein an angle made by a plane of the first short-circuit lead wire and a plane of the second short-circuit lead wire is substantially 90°.

13. The antenna device of claim 4,
wherein on a contour of the spacer, an open end of the first radiation conductor and an open end of the second radiation conductor are disposed facing each other.

14. A wireless communication device using the antenna device of claim 1.

15. A wireless communication device using the antenna device of claim 2.

16. A wireless communication device using the antenna device of claim 3.

17. A wireless communication device using the antenna device of claim 4.

18. A wireless communication device using the antenna device of claim 5.

19. A wireless communication device using the antenna device of claim 6.

20. A wireless communication device using the antenna device of claim 7.

21. A wireless communication device using the antenna device of claim 8.

22. A wireless communication device using the antenna device of claim 9.

23. A wireless communication device using the antenna device of claim 10.

24. A wireless communication device using the antenna device of claim 11.

25. A wireless communication device using the antenna device of claim 12.

26. A wireless communication device using the antenna device of claim 13.
